(19) United States
(12) Patent Application Publication
(10) Pub. No.: US 2006/0196934 A1
(43) Pub. Date: Sep. 7, 2006

(54) Security circuit and security cancellation method

(75) Inventors: Takeaki Moto, Shiga (JP); Kosei Fujisaka, Kyoto (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/365,844

(22) Filed: Mar. 2, 2006

(30) Foreign Application Priority Data
Mar. 4, 2005 (JP) 2005-059763

(51) Int. Cl. G06K 5/00

(52) U.S. Cl. 235/382

(57) ABSTRACT

A security circuit and a security cancellation method in which a code generation program 300 is input from the outside when the access security of internal resource data 360 for a semiconductor integrated circuit is to be cancelled, and in which the access security cannot be cancelled and access to the internal resource data 360 is not allowed unless matching between the input code 330 generated by operating the code generation program 300 and a security code 340 stored in advance in the semiconductor integrated circuit is confirmed. The program is not leaky in comparison with the conventional code. The security circuit and the security cancellation method can therefore have an improved security level.

### FIELD OF THE INVENTION

The present invention relates to a security circuit which cancels the security of a semiconductor integrated circuit by using a security code and to a method for this security cancellation.

### BACKGROUND OF THE INVENTION

Conventionally, semiconductor integrated circuits have generally been provided with a security circuit for the purpose of concealing data stored in the semiconductor integrated circuit from third persons. For example, the security circuit has a memory for storing a security code and is configured so that data can be read out only when the same security code as the stored security code is input. The security code is made known to a person who is permitted to read out data, and the person can read out the data. A third person who does not know the security code cannot read out the data.

The above-described conventional art, however, entails a problem that if the security code is known to a third person, the third person can cancel the security by inputting the security code and read out the concealed data.

### DISCLOSURE OF THE INVENTION

In view of the above-described problem, an object of the present invention is to provide a security circuit of a high security level and a method of security cancellation with the security circuit.

To achieve the above-described object, there is provided a security circuit having a memory storing a program transferred from the outside and used to operate an internal circuit, a CPU for executing the program, the internal circuit which generates a code generation signal by the program, a generation circuit which generates an input code from the generated code generation signal, and a comparison circuit which prohibits read/write of internal resources for a microprocessor if a security code stored in a first memory and the input code do not match each other. This arrangement of the present invention restricts access to the internal resources at the time of access to the internal resources.

A certain number of internal circuits, the corresponding number of generation circuits may be provided and the corresponding number of security codes may be stored in the first memory. Access to the internal resources can be restricted by using the plurality of security codes.

Also, a certain number of internal circuits may be provided and the generation circuit may generate one input code from code generation signals generated from the plurality of internal circuits.

Further, a generation circuit which generates an input code on the basis of program data transferred to the microprocessor and a comparison circuit which prohibits read/write of internal information if the input code and a corresponding security code do not match each other may be provided. In this way, access to the internal resources is restricted.

### BRIEF DESCRIPTION OF THE DRAWINGS

FIG. 1 is a block diagram showing a security circuit in a first embodiment of the present invention;

FIG. 2 is a flowchart showing a process according to a security cancellation method in the first embodiment;

FIG. 3 is a block diagram showing a security circuit in a second embodiment of the present invention;

FIG. 4 is a flowchart showing a process according to a security cancellation method in the second embodiment;

FIG. 5 is a block diagram showing a security circuit in a third embodiment of the present invention;

FIG. 6 is a flowchart showing a process according to a security cancellation method in the third embodiment;

FIG. 7 is a block diagram showing a security circuit in a fourth embodiment of the present invention; and

FIG. 8 is a flowchart showing a process according to a security cancellation method in the fourth embodiment.

### DESCRIPTION OF THE EMBODIMENTS

Embodiments of the present invention will be described with reference to the accompanying drawings.

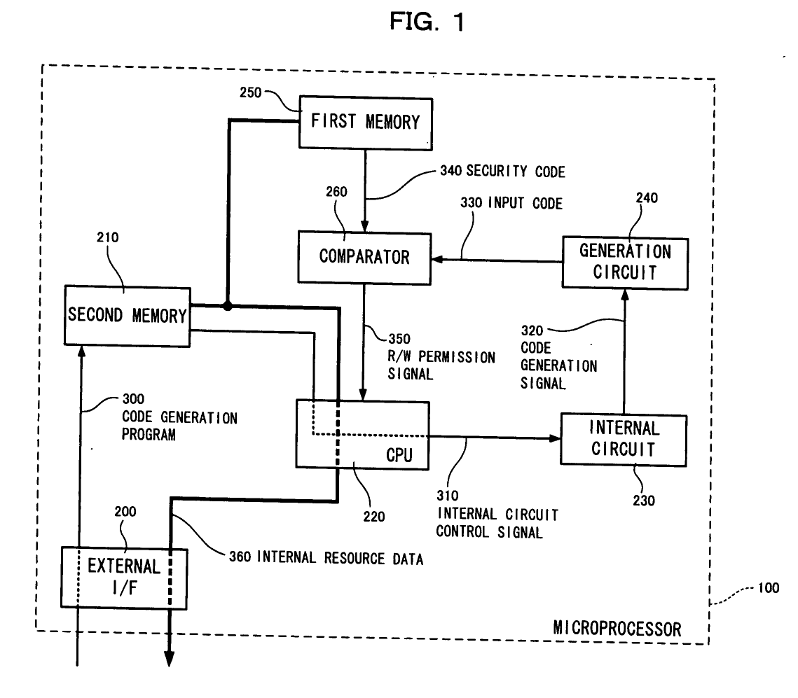

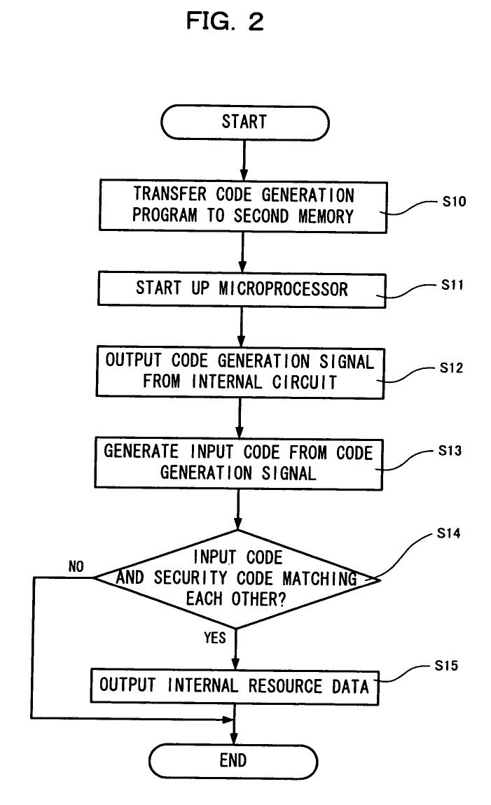

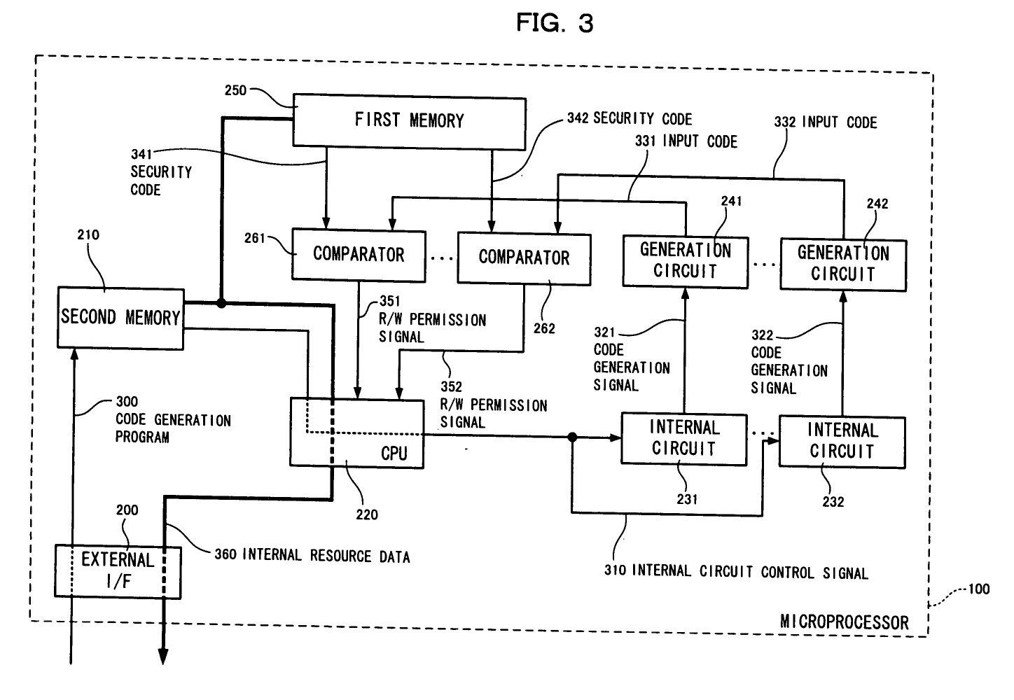

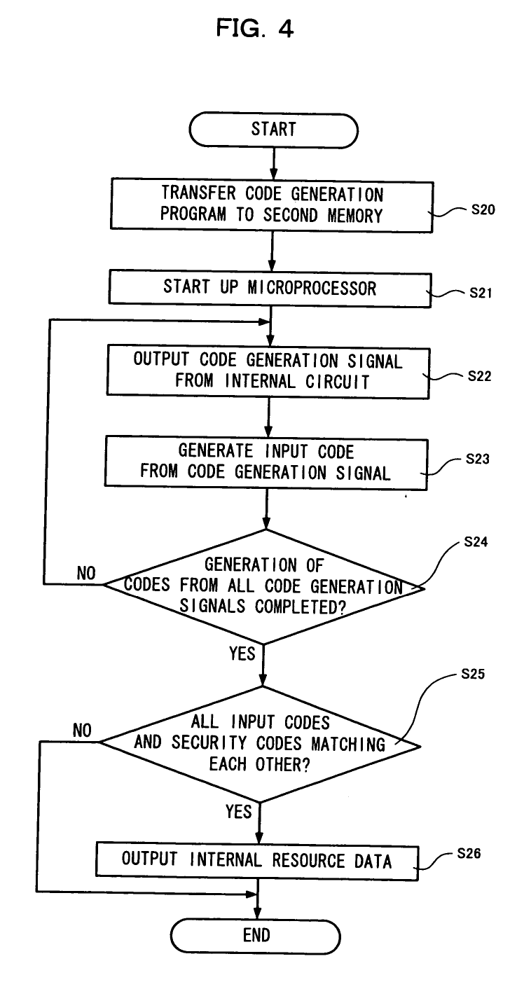

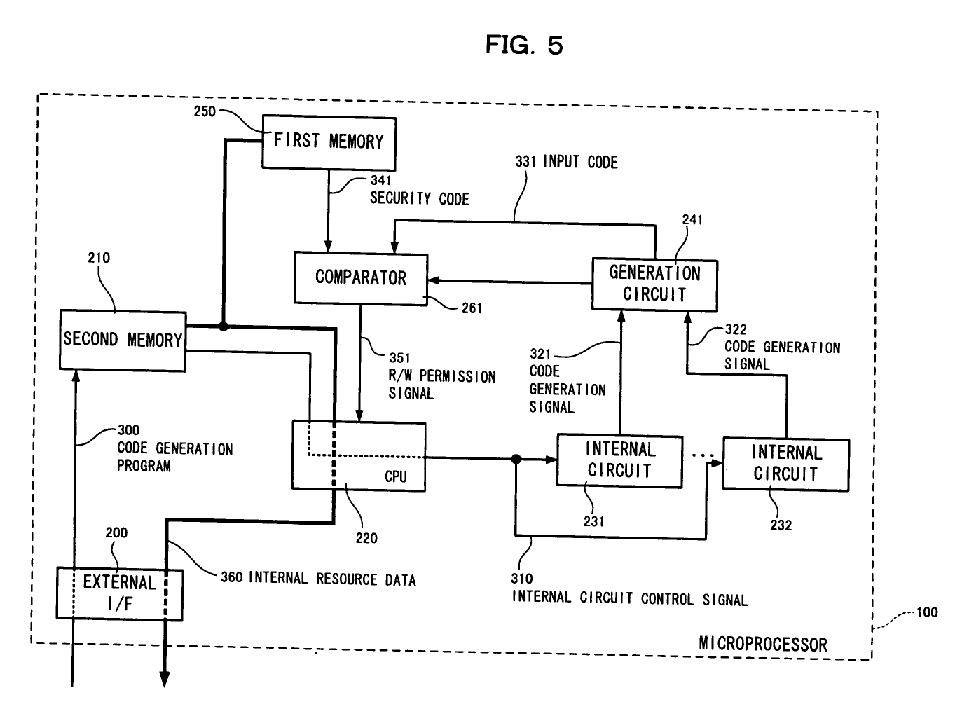

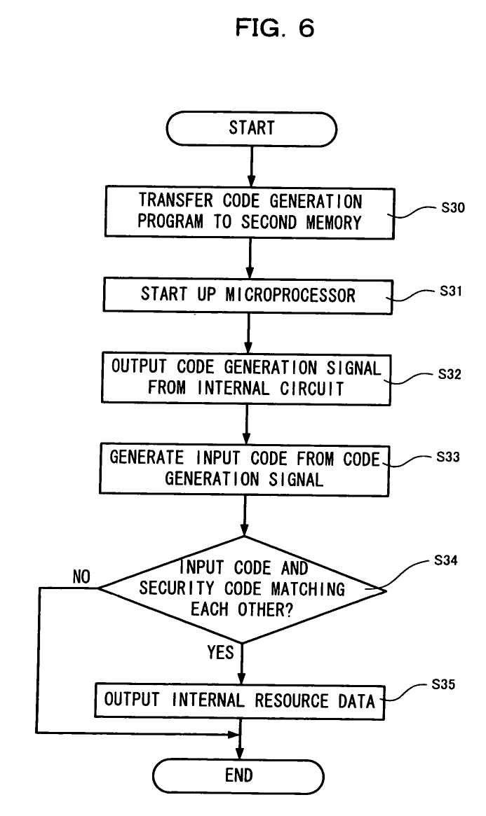

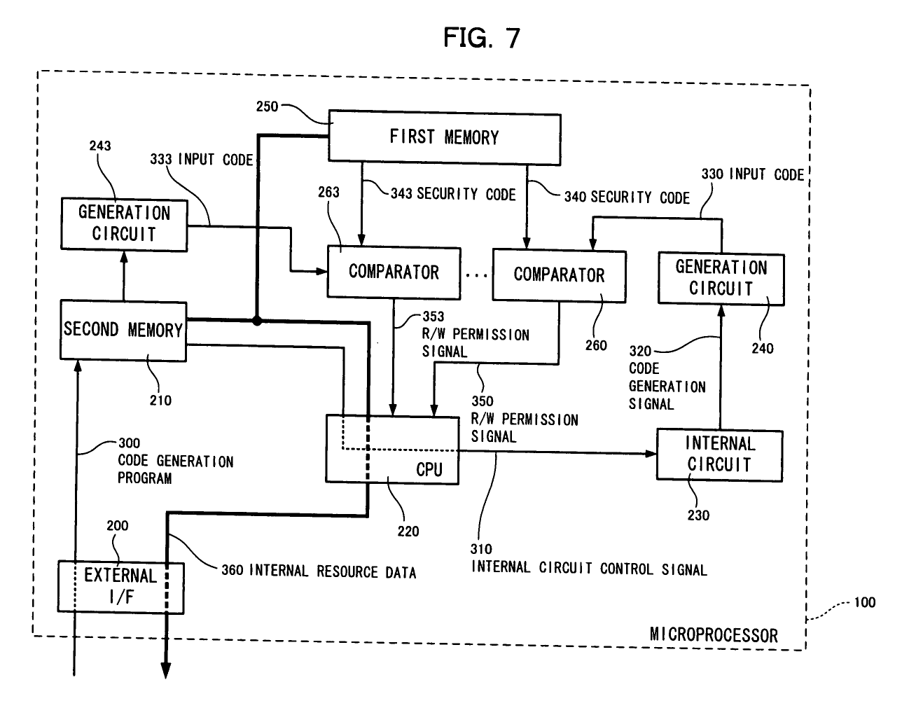

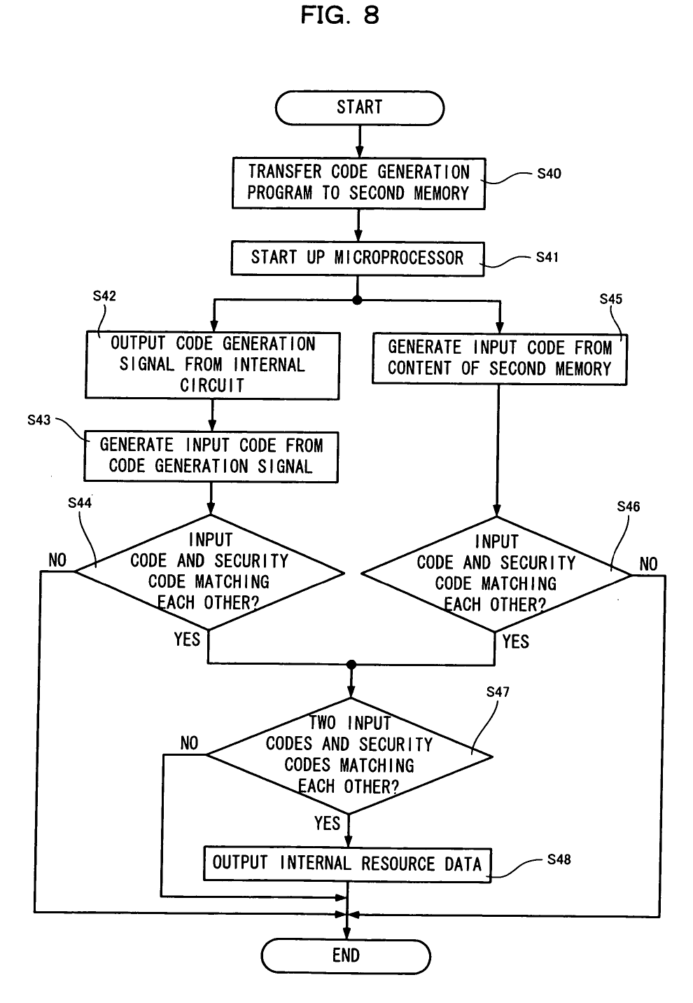

FIG. 1 is a block diagram showing a security circuit in a first embodiment of the present invention; FIG. 2 is a flowchart showing a process according to a security cancellation method in the first embodiment; FIG. 3 is a block diagram showing a security circuit in a second embodiment of the present invention; FIG. 4 is a flowchart showing a process according to a security cancellation method in the second embodiment; FIG. 5 is a block diagram showing a security circuit in a third embodiment of the present invention; FIG. 6 is a flowchart showing a process according to a security cancellation method in the third embodiment; FIG. 7 is a block diagram showing a security circuit in a fourth embodiment of the present invention; and FIG. 8 is a flowchart showing a process according to a security cancellation method in the fourth embodiment.

### First Embodiment

The first embodiment of the present invention will be described in detail with reference to FIG. 1.

FIG. 1 shows a security circuit formed by a microprocessor 100 including an external I/F 200, a second memory 210, a CPU 220, an internal circuit 230, a generation circuit 240, a first memory 250, a comparator 260, a code generation program 300, an internal circuit control signal 310, a code generation signal 320, an input code 330, a security code 340, a R/W permission signal 350, and internal resource data 360.

The microprocessor 100 is a semiconductor integrated circuit forming the security circuit including the external I/F 200, the second memory 210, the CPU 220, the internal circuit 230, the generation circuit 240, the first memory 250, the comparator 260, the code generation program 300, the internal circuit control signal 310, the code generation signal 320, the input code 330, the security code 340, the R/W permission signal 350, and the internal resource data 360.

The external I/F 200 is a circuit through which the code generation program 300 is transferred from the outside of the microprocessor 100 to the second memory 210.

The second memory 210 is a circuit for storing the code generation program 300 transferred from the outside.

The CPU 220 is a circuit which outputs the internal circuit control signal 310 for operating the internal circuit 230 according to the description of the code generation program 300 stored in the second memory 210.

The internal circuit 230 is a circuit which generates the code generation signal 320 for generating the input code 330 according to the internal circuit control signal 310.

The generation circuit 240 is a circuit which generates the input code 330 on the basis of the code generation signal 320 generated by the internal circuit 230.

The first memory 250 is a circuit for storing the security code 340 written in advance.

The comparator 260 is a circuit which compares the security code 340 stored in the first memory 250 and the input code 330 generated by the generation circuit 240 and generates the R/W permission signal 350 if the compared codes match each other.

The code generation program 300 is a program for checking matching with the security code 340 and making the CPU 220 generate the input code 330 for canceling the access security of the internal resource data 360 for the microprocessor 100.

The internal circuit control signal 310 is a signal for controlling the internal circuit 230 in order to generate the code generation signal 320.

The code generation signal 320 is a basis for generation of the input code 330 in the generation circuit 240.

The input code 330 is a code input for access to the internal resource data 360 for the microprocessor 100. Access permission is given only in the case of matching between the input code 330 and the security code 340 recognized as a comparison result.

The security code 340 is stored in advance and used to cancel the access security of the internal resource data 360.

The R/W permission signal 350 is a signal for permitting access to the internal resource data 360 when the input code 330 and the security code 340 match each other.

The internal resource data 360 is the whole of internal information used in the microprocessor 100.

The operation of the first embodiment will now be described with reference to FIG. 2.

When access to the internal resource data 360 for the microprocessor 100 is made, the code generation program 300 input from the outside of the microprocessor 100 is transferred to the second memory 210 through the external I/F 200 (S10). The CPU 220 then reads out the code generation program 300 stored in the second memory 210 and operates the internal circuit 230 in accordance with the code generation program 300 (S11) to generate the code generation signal 320 (S12). Subsequently, the generation circuit 240 generates the input code 330 by using a certain rule from the code generation signal 320 generated by the internal circuit 230 (S13). The comparator 260 determines by comparison whether or not the input code 330 and the security code 340 stored in the first memory 250 match each other (S14). If the input code 330 and the security code 340 match each other, the R/W permission signal 350 is output from the comparator 260 to the CPU 220 to enable the CPU 220 to access the internal resource data 360 via the external I/F 200 (S15). If the input code 330 and the security code 340 do not match each other, the R/W permission signal 350 is not output from the comparator 260 to the CPU 220 and the CPU 220 cannot access the internal resource data 360.

As described above, the code generation program 300 is input from the outside when the access security of the internal resource data 360 for the microprocessor 100 is to be cancelled, and the access security cannot be cancelled unless matching between the input code 330 generated by operating the code generation program 300 and the security code 340 stored in advance is confirmed. Thus, the security circuit and security cancellation method capable of access control using the program for generating a suitable code complicated and not leaky in comparison with an ordinary input code (selectable among 2^{S} codes if the code bit width is S) and having a high security level can be provided.

### Second Embodiment

The second embodiment will be described in detail with reference to FIGS. 3 and 4.

FIG. 3 shows a security circuit formed by a microprocessor 100 including an external I/F 200, a second memory 210, a CPU 220, M number of internal circuits 231, 232, . . . , M number of generation circuits 241, 242, . . . , a first memory 250, M number of comparators 261, 262, . . . , a code generation program 300, an internal circuit control signal 310, M number of code generation signals 321, 322, . . . , M number of input codes 331, 322, . . . , M number of security codes 341, 342, . . . , M number of R/W permission signals 351, 352, . . . , and internal resource data 360.

The microprocessor 100 is a semiconductor integrated circuit forming the security circuit including the external I/F 200, the second memory 210, the CPU 220, the M number of internal circuits 231, 232, . . . , the M number of generation circuits 241, 242, . . . , the first memory 250, the M number of comparators 261, 262, . . . , the code generation program 300, the internal circuit control signal 310, the M number of code generation signals 321, 322, . . . , the M number of input codes 331, 322, .. ., the M number of security codes 341, 342, the M number of R/W permission signals 351, 352, . . . , and the internal resource data 360.

The external I/F 200 is a circuit through which the code generation program 300 is transferred from the outside of the microprocessor 100 to the second memory 210.

The second memory 210 is a circuit for storing the code generation program 300 transferred from the outside.

The CPU 220 is a circuit which outputs the internal circuit control signal 310 for operating the M number of internal circuits 231, 232, . . . according to the code generation program 300 stored in the second memory 210.

The internal circuit 231 is a circuit which generates the code generation signal 321 for generating the input code 331 according to the internal circuit control signal 310.

The internal circuit 232 is a circuit which generates the code generation signal 322 for generating the input code 332 according to the internal circuit control signal 310. The number of the internal circuits is a number M freely selected in correspondence with the number of security codes storable in the first memory 250.

The generation circuit 241 is a circuit which generates the input code 331 on the basis of the code generation signal 321 generated by the internal circuit 231.

The generation circuit 242 is a circuit which generates the input code 332 on the basis of the code generation signal 322 generated by the internal circuit 232. The number of the generation circuits is the number M freely selected in correspondence with the number of security codes storable in the first memory 250.

The first memory 250 is a circuit for storing the M number of security codes 341, 342, . . . written in advance.

The comparator 261 is a circuit which compares the security code 341 stored in the first memory 250 and the input code 331 generated by the generation circuit 241 and generates the R/W permission signal 351 if the compared codes match each other.

The comparator 262 is a circuit which compares the security code 342 stored in the first memory 250 and the input code 332 generated by the generation circuit 242 and generates the R/W permission signal 352 if the compared codes match each other. The number of the comparators is the number M freely selected in correspondence with the number of security codes storable in the first memory 250.

The code generation program 300 is a program for checking matching with the security codes 341 and 342 and making the CPU 220 generate the input codes 331, 332, . . . for canceling the access security of the internal resource data 360 for the microprocessor 100.

The internal circuit control signal 310 is a signal for controlling the M number of internal circuits 231, 232, . . . in order to generate the M number of code generation signals 321, 322, . . . .

The code generation signal 321 is a basis for generation of the input code 331 in the generation circuit 241.

The code generation signal 322 is a basis for generation of the input code 332 in the generation circuit 242. The number of the code generation signals is the number M freely selected. Each of the M number of internal circuits outputs one code generation signal.

The input code 331 is a code input for access to the internal resource data 360 for the microprocessor 100. Access permission is given only in the case of matching between the input code 331 and the security code 341 recognized as a comparison result.

The input code 332 is a code input for access to the internal resource data 360 for the microprocessor 100. Access permission is given only in the case of matching between the input code 332 and the security code 342 recognized as a comparison result. The number of the input codes is the number M freely selected. Each generation circuit outputs one code generation signal.

The security code 341 is stored in advance and used to cancel the access security of the internal resource data 360.

The security code 342 is stored in advance and used to cancel the access security of the internal resource data 360. The number of the security codes is the number M freely selected. In the security circuit of the second embodiment, the number of input codes corresponding to the number of security codes are generated.

The R/W permission signal 351 is a signal for permitting access to the internal resource data 360 when the input code 331 and the security code 341 match each other.

The R/W permission signal 352 is a signal for permitting access to the internal resource data 360 when the input code 332 and the security code 342 match each other. The number of the R/W permission signals is the number M freely selected. Each comparator outputs one R/W permission signal. The access security of the internal resource data 360 is cancelled only after all the M number of R/W permission signals have been output.

The internal resource data 360 is the whole of internal information used in the microprocessor 100.

The operation of the second embodiment will now be described with reference to FIG. 4.

When access to the internal resource data 360 for the microprocessor 100 is made, the code generation program 300 input from the outside of the microprocessor 100 is transferred to the second memory 210 through the external I/F 200 (S20). The CPU 220 then reads out the code generation program 300 stored in the second memory 210 and operates the M number of internal circuits 231, 232, . . . in accordance with the code generation program 300 (S21) to generate the M number of code generation signals 321, 322, . . . (S22). Subsequently, the M number of generation circuits 241, 242, . . . generate the input codes 331, 332, . . . by using a certain rule from the code generation signals 321, 322, . . . generated by the M number of internal circuits 231, 232, . . . (S23, S24). The M number of comparators 261, 262, . . . determine by comparison whether or not the M number of input codes 331, 332, . . . and the M number of security codes 341, 342, . . . stored in the first memory 250 completely match each other (S25). If the input codes 331, 332, . . . and the security codes 341, 342, . . . completely match each other, the M number of R/W permission signals 351, 352, . . . are output from the comparators 261, 262, . . . to the CPU 220. Only in the case of receiving all the R/W permission signals, the CPU 220 can access the internal resource data 360 via the external I/F 200 (S26). If the codes do not completely match each other, not all the R/W permission signals 351, 352, . . . from the comparators 261, 262, . . . are output to the CPU 220 and the CPU 220 cannot access the internal resource data 360.

As described above, the code generation program 300 necessary for generation of the M number of input codes is input from the outside when the access security of the internal resource data 360 for the microprocessor 100 is to be cancelled; matching between the M number of input codes 331, 332, . . . generated by operating the code generation program 300 and the security codes 341, 342, . . . stored in advance is checked; and access to the internal resource data 360 cannot be made unless all the input codes generated by the code generation program 300 completely match the corresponding security codes. Thus, the security circuit and security cancellation method having a high security level can be provided.

### Third Embodiment

The third embodiment will be described in detail with reference to FIGS. 5 and 6.

FIG. 5 shows a security circuit formed by a microprocessor 100 including an external I/F 200, a second memory 210, a CPU 220, M number of internal circuits 231, 232, . . . , a generation circuit 241, a first memory 250, a comparators 261, a code generation program 300, an internal circuit control signal 310, M number of code generation signals 321, 322, . . . , an input code 331, a security code 341, a R/W permission signal 351, and internal resource data 360.

The microprocessor 100 is a semiconductor integrated circuit forming the security circuit including the external I/F 200, the second memory 210, the CPU 220, the M number of internal circuits 231, 232, . . . , the generation circuit 241, the first memory 250, the comparators 261, the code generation program 300, the internal circuit control signal 310, the M number of code generation signals 321, 322, . . . , the input code 331, the security code 341, the R/W permission signal 351, and the internal resource data 360.

The external I/F 200 is a circuit through which the code generation program 300 is transferred from the outside of the microprocessor 100 to the second memory 210.

The second memory 210 is a circuit for storing the code generation program 300 transferred from the outside.

The CPU 220 is a circuit which outputs the internal circuit control signal 310 for operating the internal circuits 231, 232, . . . according to the code generation program 300 stored in the second memory 210.

The internal circuit 231 is a circuit which generates the code generation signal 321 for generating the input code 331 according to the internal circuit control signal 310.

The internal circuit 232 is a circuit which generates the code generation signal 322 for generating the input code 331 according to the internal circuit control signal 310. The number of the internal circuits is a number M freely selected in correspondence with the number of internal circuit control signals generated by the code generation program 300.

The generation circuit 241 is a circuit which generates the input code 331 on the basis of the M number of code generation signals 321, 322, . . . generated by the M number of internal circuits 231, 232, . . . .

The first memory 250 is a circuit for storing the security code 341 written in advance.

The comparator 261 is a circuit which compares the security code 341 stored in the first memory 250 and the input code 331 generated by the generation circuit 241 and generates the R/W permission signal 351 if the compared codes match each other.

The code generation program 300 is a program for checking matching with the security code 341 and making the CPU 220 generate the input code 331 for canceling the access security of the internal resource data 360 for the microprocessor 100. The code generation program 300 is a set of M number of programs for generating M number of code generation signals.

The internal circuit control signal 310 comprises M number of control signals for controlling the M number of internal circuits 231, 232, . . . in order to generate the M number of code generation signals 321, 322, . . . .

The code generation signal 321 is a basis for generation of the input code 331 in the generation circuit 241.

The code generation signal 322 is a basis for generation of the input code 331 in the generation circuit 241. The number of the code generation signals is the number M freely selected. Each of the M number of internal circuits outputs one code generation signal.

The input code 331 is a code input for access to the internal resource data 360 for the microprocessor 100. Access permission is given only in the case of matching between the input code 331 and the security code 341 recognized as a comparison result.

The security code 341 is stored in advance and used to access the internal resource data 360.

The R/W permission signal 351 is a signal for permitting access to the internal resource data 360 when the input code 331 and the security code 341 match each other.

The internal resource data 360 is the whole of internal information used in the microprocessor 100.

The operation of the third embodiment will now be described with reference to FIG. 6.

When access to the internal resource data 360 for the microprocessor 100 is made, the code generation program 300 input from the outside of the microprocessor 100 is transferred to the second memory 210 through the external I/F 200 (S30). The CPU 220 then reads out the code generation program 300 stored in the second memory 210 and operates the M number of internal circuits 231, 232, . . . in accordance with the code generation program 300 (S31) to generate the M number of code generation signals 321, 322, . . . (S32). Subsequently, the generation circuit 241 generates one input code 331 by using a certain rule from the code generation signals 321, 322, . . . generated by the M number of internal circuits 231, 232, . . . (S33). The comparator 261 determines by comparison whether or not the input code 331 and the security code 341 stored in the first memory 250 match each other (S34). If the input code 331 and the security code 341 match each other, the R/W permission signal 351 is output from the comparator 261 to the CPU 220 to enable the CPU 220 to access the internal resource data 360 via the external I/F 200 (S35). If the codes do not match each other, the R/W permission signal 351 is not output from the comparators 261 to the CPU 220 and the CPU 220 cannot access the internal resource data 360.

As described above, the code generation program 300 for generating one input code 331 by using M number of code generation signals as an intermediate file is input from the outside when the access security of the internal resource data 360 for the microprocessor 100 is to be cancelled, and the access security is not cancelled unless matching between the input code 331 and the security code 341 stored in advance is confirmed. Thus, the security circuit and security cancellation method having a high security level can be provided. Also, the scale of the circuit can be reduced in comparison with the second embodiment.

### Fourth Embodiment

The fourth embodiment will be described in detail with reference to FIGS. 7 and 8.

FIG. 7 shows a security circuit formed by a microprocessor 100 including an external I/F 200, a second memory 210, a CPU 220, an internal circuit 230, generation circuits 240 and 243, a first memory 250, comparators 260 and 263, a code generation program 300, an internal circuit control signal 310, a code generation signal 320, input codes 330 and 333, security codes 340 and 343, R/W permission signals 350 and 353, and internal resource data 360.

The microprocessor 100 is a semiconductor integrated circuit forming the security circuit including the external I/F 200, the second memory 210, the CPU 220, the internal circuit 230, the generation circuits 240 and 243, the first memory 250, the comparators 260 and 263, the code generation program 300, the internal circuit control signal 310, the code generation signal 320, the input codes 330 and 333, the security codes 340 and 343, the R/W permission signals 350 and 353, and the internal resource data 360.

The external I/F 200 is a circuit through which the code generation program 300 is transferred from the outside of the microprocessor 100 to the second memory 210.

The second memory 210 is a circuit for storing the code generation program 300 transferred from the outside.

The CPU 220 is a circuit which outputs the internal circuit control signal 310 for operating the internal circuit 230 according to the code generation program 300 stored in the second memory 210.

The internal circuit 230 is a circuit which generates the code generation signal 320 for generating the input code 330 according to the internal circuit control signal 310.

The generation circuit 240 is a circuit which generates the input code 330 on the basis of the code generation signal 320 generated by the internal circuit 230.

The generation circuit 243 is a circuit which generates the input code 333 on the basis of the contents of the code generation program 300 stored in the second memory 210.

The first memory 250 is a circuit for storing the security codes 340 and 343 written in advance.

The comparator 260 is a circuit which compares the security code 340 stored in the first memory 250 and the input code 330 generated by the generation circuit 240 and generates the R/W permission signal 350 if the compared codes match each other.

The comparator 263 is a circuit which compares the security code 343 stored in the first memory 250 and the input code 333 generated by the generation circuit 243 and generates the R/W permission signal 353 if the compared codes match each other.

The code generation program 300 is a program for checking matching with the security code 340 and making the CPU 220 generate the input code 330 for canceling the access security of the internal resource data 360 for the microprocessor 100.

The code generation program 300 also has a control signal for checking matching with the security code 343 and making the generation circuit 243 generate the input code 333 for canceling the access security of the internal resource data 360 for the microprocessor 100.

The internal circuit control signal 310 is a signal for controlling the internal circuits 230 in order to generate the code generation signals 320.

The code generation signal 320 is a basis for generation of the input code 330 in the generation circuit 240.

The input code 330 is a code input for access to the internal resource data 360 for the microprocessor 100. Access permission is given only in the case of matching between the input code 330 and the security code 340 recognized as a comparison result.

The input code 333 is a code input for access to the internal resource data 360 for the microprocessor 100. Access permission is given only in the case of matching between the input code 333 and the security code 343 recognized as a comparison result.

The security code 340 is stored in advance and used to access the internal resource data 360.

The security code 343 is stored in advance and used to access the internal resource data 360.

The R/W permission signal 350 is a signal for permitting access to the internal resource data 360 when the input code 330 and the security code 340 match each other.

The R/W permission signal 353 is a signal for permitting access to the internal resource data 360 when the input code 333 and the security code 343 match each other. The access security of the internal resource data 360 is cancelled only when both the R/W permission signals 350 and 353 are output.

The internal resource data 360 is the whole of internal information used in the microprocessor 100.

The operation of the fourth embodiment will now be described with reference to FIG. 8.

When access to the internal resource data 360 for the microprocessor 100 is made, the code generation program 300 input from the outside of the microprocessor 100 is transferred to the second memory 210 through the external I/F 200 (S40). The CPU 220 then reads out the code generation program 300 stored in the second memory 210 and operates the internal circuit 230 in accordance with the code generation program 300 (S41) to generate the code generation signal 320 (S42). Subsequently, the generation circuit 240 generates the input code 330 by using a certain rule from the code generation signal 320 generated by the internal circuit 230 (S43). The comparator 260 determines by comparison whether or not the input code 330 and the security code 340 stored in the first memory 250 match each other (S44). If the input code 330 and the security code 340 match each other, the R/W permission signal 350 is output from the comparator 260 to the CPU 220. Also, the generation circuit 240 generates the input code 333 by using a certain rule on the basis of the control signal described in the code generation program 300 stored in the second memory 210 (S45). The comparator 263 determines by comparison whether or not the input code 333 and the security code 343 stored in the first memory 250 match each other (S46). If the input code 333 and the security code 343 match each other, the R/W permission signal 353 is output from the comparator 263 to the CPU 220. Only when the CPU 220 detects both the R/W permission signals 350 and 353 (S47), it can access the internal resource data 360 via the external I/F 200 (S48). If the input codes and the security codes do not completely match each other, the R/W permission signal 350 and/or the R/W permission signal 353 is not output to the CPU 220 and the CPU 220 cannot access the internal resource data 360.

In the above-described fourth embodiment, an arrangement for an input code is further generated from the input code generation program and a comparison with the corresponding the security code is made is added to the first embodiment. The same arrangement may also be added to each of the second and third embodiments.

As described above, the code generation program 300 including a program for generating the input code 330 and a control signal for making the generation circuit 243 generate the input code 333 is input from the outside when the access security of the internal resource data 360 for the microprocessor 100 is to be cancelled, and the access security of the internal resource data 360 cannot be cancelled unless complete matching between the two input codes and the corresponding security code 341 stored in advance is not confirmed. Thus, the security circuit and security cancellation method having a high security level can be provided. Also, the scale of the circuit can be reduced in comparison with the second embodiment.

While the microprocessor has been described by way of example, the present invention can be applied to any other semiconductor integrated circuits capable of operating the program.

While the arrangement has been described in which when an input code is generated by a code generation program, a code generation signal is output by operating an internal circuit according to a control signal generated by operating a CPU and the input code is generated by a generation circuit according to the code generation signal, any arrangement other than that described above may also be adopted if the predetermined input code can be generated by a code generation program.

What is claimed is:

1. A security circuit which restricts access to internal resource data for a semiconductor integrated circuit, the security circuit comprising:
a first memory storing at least one security code;
an external interface through which a security code generation program is input from the outside;
a second memory storing the security code generation program;
an input code generation circuit which generates at least one input code corresponding to the at least one security code by the security code generation program; and
a comparator which compares the security code stored in advance and the corresponding input code,
wherein access to the internal resource data can be made only when a complete match occurs between the at least one combination of the security code and the input code corresponding to each other.

2. A security circuit which restricts access to internal resource data for a semiconductor integrated circuit, the security circuit comprising:
a first memory storing at least one security code;
an external interface through which a security code generation program is input from the outside;
a second memory storing the security code generation program;
a CPU which generates an internal circuit control signal by operating the security code generation program;
at least one internal circuit which generates a code generation signal corresponding to the security code while being controlled by means of the internal circuit control signal;
at least one code generation circuit which generates an input code corresponding to the security code on the basis of the code generation signal; and
a comparator which compares the security code stored in advance and the corresponding input code,
wherein access to the internal resource data can be made only when a complete match occurs between the at least one combination of the security code and the input code corresponding to each other.

3. A security circuit which restricts access to internal resource data for a semiconductor integrated circuit, the security circuit comprising:
a first memory storing a security code;
an external interface through which a security code generation program is input from the outside;
a second memory storing the security code generation program;
a CPU which generates an internal circuit control signal by operating the security code generation program;
at least one internal circuit which generates a code generation signal corresponding to the security code while being controlled by means of the internal circuit control signal;
at least one generation circuit which generates an input code on the basis of the at least one code generation signal; and
a comparator which compares the security code stored in advance and the input code,
wherein access to the internal resource data can be made only when the security code and the input code match each other.

4. A security circuit which restricts access to internal resource data for a semiconductor integrated circuit, the security circuit comprising:
a first memory storing at least one first security code and a second security code;
an external interface through which a security code generation program is input from the outside;
a second memory storing the security code generation program;
a CPU which generates an internal circuit control signal by operating the security code generation program;
at least one internal circuit which generates a code generation signal corresponding to the first security code while being controlled by means of the internal circuit control signal;
at least one code generation circuit which generates a first input code corresponding to the first security code on the basis of the code generation signal;
an input code generation circuit which generates a second input code on the basis of the security code generation program;
a code comparator which compares the second security code and the second input code; and
a comparator which compares the first security code stored in advance and the corresponding first input code,
wherein access to the internal resource data can be made only when a complete match occurs in the result of comparison by the comparator and the result of comparison by the code comparator.

5. A security circuit which restricts access to internal resource data for a semiconductor integrated circuit, the security circuit comprising:
a first memory storing a first security code and a second security code;
an external interface through which a security code generation program is input from the outside;
a second memory storing the security code generation program;
a CPU which generates an internal circuit control signal by operating the security code generation program;
at least one internal circuit which generates a code generation signal while being controlled by means of the internal circuit control signal;
at least one code generation circuit which generates a first input code on the basis of the at least one code generation signal;
an input code generation circuit which generates a second input code on the basis of the security code generation program;
a code comparator which compares the second security code and the second input code; and
a comparator which compares the first security code stored in advance and the first input code,
wherein access to the internal resource data can be made only when a complete match occurs in the result of comparison by the comparator and the result of comparison by the code comparator.

6. A security cancellation method comprising, when canceling the access security of internal resource data for a semiconductor integrated circuit:
inputting a code generation program from the outside;
generating at least one input code by the code generation program;
comparing the at least one security code stored in advance and the corresponding input code; and
canceling the access security of the internal resource data only when a complete match occurs between the at least one combination of the security code and the input code corresponding to each other.
